(19) United States
(12) Patent Application Publication
(10) Pub. No.: US 2024/0140532 A1
(43) Pub. Date: May 2, 2024

(54) REINFORCING SYSTEM FOR A MOTOR VEHICLE FLOOR

(71) Applicant: PSA AUTOMOBILES SA, Poissy (FR)

(72) Inventors: Marc PERU, CHATENAY MALABRY (FR); Stephane FONFREDE, BELFORT (FR); Richard ZEITOUNI, BOIS D'ARCY (FR)

(21) Appl. No.: 18/548,045

(22) PCT Filed: Feb. 23, 2022
(86) PCT No.: PCT/FR2022/050329

§ 371 Date: Aug. 25, 2023

(30) Foreign Application Priority Data
Mar. 25, 2021 (FR) FR2103034

(51) Int. Cl. B62D 21/15; B62D 25/20

(52) U.S. Cl. CPC B62D 21/157; B62D 25/20

(57) ABSTRACT

The invention relates to a reinforcing system (5) for a motor vehicle floor, the reinforcing system (5) comprising an upper plate comprising members for fastening to the floor, an impact absorption zone (10) and a reinforcing zone (11). The absorption zone (10) is secured to the upper plate and is configured to be able to deform with constant force under the effect of an impact. The reinforcing zone (11) is rigid, is configured to be able to transmit a compressive force subsequent to the impact, is secured to the upper plate and extends longitudinally in the continuation of the absorption zone (10).

### CROSS-REFERENCE TO RELATED APPLICATIONS

This application is the US National Stage under 35 USC § 371 of International Application No. PCT/FR2022/050329, filed Feb. 23, 2022, which claims the priority of the French application 2103034 filed on Mar. 25, 2021, the content (text, drawings and claims) of both said applications being incorporated by reference herein.

### BACKGROUND

The technical context is that of structural elements fitted to a motor vehicle, and more particularly protection assemblies configured to absorb a lateral impact to the motor vehicle. More particularly, a reinforcing system for a motor vehicle floor is related herein.

In the prior art, structural elements of motor vehicles and in particular protection assemblies configured to absorb an impact occurring at the motor vehicle are known. These protective assemblies make it possible to dissipate the impact in order to protect the elements of the motor vehicle, in particular the elements located at an engine compartment of said motor vehicle, as well as the elements located at a passenger compartment of the motor vehicle, just like their occupants.

Among these protection assemblies, “diagonal” reinforcements and side-member reinforcements are known, housed inside doors of motor vehicles. The diagonal reinforcements and the side members make it possible to limit intrusions in case of a “side barrier impact”, in other words during a lateral impact against an extended surface, such as a lateral impact induced by another wheeled vehicle laterally striking the motor vehicle.

The disadvantage of these reinforcements is that they offer inefficient lateral protection in the event of a “side pole impact”, in other words in the event of a lateral impact against a narrow surface, such as a fixed obstacle taking the form of a pole or a post.

Also known are reinforcing structures formed of two cross-members extending laterally on a floor of the motor vehicle, behind the side doors of the motor vehicle. The two cross-members increase the rigidity of the floor during a lateral impact, in particular during a “side pole impact”, in other words in the event of a lateral impact against a narrow surface, such as a fixed obstacle taking the form of a tree or pole.

One drawback of these reinforcement structures formed by two cross-members is that, for electric motor vehicles, their energy-absorbing capacity in the event of a “side pole impact” may be insufficient to protect electric batteries of the motor vehicle located under a floor referred to as an electric motor vehicle, behind the diagonal reinforcements and side members.

### SUMMARY

The present description aims to provide a new reinforcing system for a motor vehicle floor in order to address at least some of the preceding problems and to further lead to other advantages.

Another aim is to propose a compact reinforcing system for a motor vehicle floor, guaranteeing the compactness and the lightness of the motor vehicle.

Another aim is to propose an inexpensive reinforcing system for a motor vehicle floor, so as not to negatively impact the cost of the motor vehicle.

Another aim is to propose a simple reinforcing system for a motor vehicle floor, both in terms of implementation thereof, and in terms of manufacture thereof.

Another aim is to propose a reinforcing system for a motor vehicle floor which is more satisfactory in terms of reducing electrical risks.

According to a first aspect, at least one of the aforementioned objectives is achieved with a reinforcing system for a motor vehicle floor, the reinforcing system comprising (i) an upper plate comprising members for fastening to the floor, (ii) an impact absorption zone secured to the upper plate, the absorption zone being configured to be able to deform with constant force under the effect of an impact, (iii) a rigid reinforcing zone configured to be able to transmit a compressive force consecutive to the impact, the reinforcing zone being secured to the upper plate and extending longitudinally in the continuation of the absorption zone.

In the reinforcing system according to the first aspect, the upper plate rigidly and simultaneously fastens the absorption zone and the reinforcing zone. The upper plate is a generally planar part, which extends in a main plane.

In the reinforcing system according to the first aspect, the absorption zone is configured to be able to absorb an impact. The absorption zone is configured to be deformed following the impact to absorb said impact. In the motor vehicle equipped with the reinforcing system, the absorption zone is configured to be between a lateral flank of the motor vehicle and the reinforcing zone. It will be understood that the absorption zone is configured to be able to absorb a compressive force consecutive to a “side pole impact”. In other words, the absorption zone is configured to be able to absorb a lateral impact against a narrow surface, such as a stationary obstacle taking the form of a tree or pole. Thus, the absorption zone makes it possible to absorb an impact by compression to preserve any element located laterally behind said absorption zone. In particular, in the case of an electric motor vehicle equipped with the shock absorber assembly, the absorption zone makes it possible to protect the electric batteries of the motor vehicle located under a floor of an electric motor vehicle.

In the reinforcing system according to the first aspect, the reinforcing zone allows a force transmission. “Rigid” means that the rigid reinforcing zone is distinguished from the absorption zone configured to undergo deformation. In other words, the reinforcing zone is configured to be resistant to mechanical deformation induced by a side pole impact.

By being in the continuation of the absorption zone, the reinforcing zone makes it possible to transmit a force coming from the absorption zone. The force from the absorption zone is a portion of force that is not absorbed by the absorption zone and transmitted in the reinforcing zone. It will be understood that the reinforcing zone is configured to be able to transmit a compressive force consecutive to a “side pole impact” transmitted by the absorption zone. Thus, the reinforcing zone makes it possible to protect from compression any element located laterally behind said absorption zone, above and below the reinforcing zone. In particular, in the case of an electric motor vehicle equipped with the shock absorber assembly, the reinforcing zone makes it possible to protect the electric batteries of the motor vehicle located under the floor of an electric motor vehicle.

Such a reinforcing system, by combining an impact absorption function intended to be implemented upstream of an impact dissipation function, makes it possible to reinforce the floor of a motor vehicle. Such a reinforcing system improves the distribution of forces at the floor of the motor vehicle that it equips and makes it possible to keep the floor rigid. Thus, this solution makes it possible to protect the electric batteries of the motor vehicle located under the floor of an electric motor vehicle, while being simple to implement. The reinforcing system has the advantage of overcoming the disadvantages cited above, without having to provide significant changes to the floor that it equips.

The reinforcing system in accordance with the first aspect advantageously comprises at least one of the improvements hereinbelow; the technical features forming these improvements could be considered separately or in combination:
the absorption zone comprises at least one absorption block configured to deform with constant force, each at least one absorption block being secured to the upper plate. In the absorption zone, the at least one absorption block is configured to be able to absorb an impact. The at least one absorption block is configured to be deformed following the impact to absorb said impact. It will be understood that the at least one absorption block is configured to be able to absorb a compressive force consecutive to a “side pole impact”. In other words, the at least one absorption block is configured to be able to absorb a lateral impact against a narrow surface, such as a stationary obstacle taking the form of a tree or pole. Thus, the at least one absorption block makes it possible to absorb an impact by compression to preserve any element located laterally behind the absorption zone. In particular, in the case of an electric motor vehicle equipped with the shock absorber assembly, the at least one absorption block makes it possible to protect the electric batteries of the motor vehicle located under a floor of an electric motor vehicle.
each absorption block is formed of a honeycomb structure. It will be understood that such an absorption block has a profile having several closed cells. Such an absorption block facilitates deformation by compression, making it possible to dissipate the compressive force induced by an impact. For example, each absorption block is formed of a hollow lattice structure. Such an absorption block is optimized so that it can be compressed;
each absorption block is formed of a honeycomb structure;
each absorption block is formed of a deformable material, such as for example a synthetic foam, preferentially one that is hard. Each absorption block is provided with elasticity, in the sense that their deformability results from an extension or a compaction of their elastic material. Such an absorption block advantageously allows a passage to be provided therein, intended for the passage and protection of an electrical beam;
for example, each absorption block is obtained by 3D printing. This industrial forming method makes it possible to obtain, at lower cost, a large number of units of identical volume by adding material in successive layers from a three-dimensional computer model, in particular designed from a computer-assisted design (CAD) tool. An example of 3D printing is by laser polymerization in a resin tank, or in additive mode. Alternatively, each absorption block is obtained by molding. This industrial forming method allows a large number of identical units to be obtained at a lower cost, by repeatedly using the same mold;
the absorption zone is non-detachably secured to the upper plate. “Non-detachably” means that the absorption zone is permanently fixed to the upper plate, the absorption zone and the upper plate are unable to be separated from one another by destroying and/or damaging part of the absorption zone and/or part of the upper plate. A non-detachable fastening means is for example gluing or welding;
the rigid reinforcing zone comprises at least one reinforcing ribbed member secured to the upper plate, each ribbed member projecting from the upper plate and extending longitudinally from the absorption zone and towards an opposite edge of the upper plate. The at least one ribbed member is configured to reinforce robustness against the mechanical forces that may be imposed on the reinforcing zone. In particular, the at least one ribbed member is configured to reinforce the robustness of the reinforcing zone against a force corresponding to an impact by compression. The at least one ribbed member projects from the upper plate and makes it possible to keep the upper plate fixed relative to the reinforcing zone despite an impact by compression;
each ribbed member comprises at least two ribs extending parallel to each other and having a rectangular transverse profile. The at least two ribs are configured to reinforce robustness to the mechanical forces that can be imposed on the ribbed member. In particular, the at least two ribbed members are configured to reinforce the robustness of the ribbed member against a force corresponding to an impact by compression. The at least two ribs project from the upper plate and make it possible to keep the upper plate fixed relative to the reinforcing zone despite an impact by compression. Such a ribbed member with at least two ribs makes it possible to reinforce the reinforcing zone;
each ribbed member is formed of a composite material comprising a plastic material reinforced with a fibrous material. The fibrous material increases the rigidity of the plastic material. Such a fiber-filled composite material has strengthened mechanical properties of resistance to deformations;
in the composite material forming each ribbed member, the plastic material is for example polypropylene;
in the composite material forming each ribbed member, the fibrous material is for example PMC, standing for “Phenolic Moulding Compounds” or SMC, standing for “Sheet Moulding Compounds”;
the reinforcing zone is non-detachably secured to the upper plate. “Non-detachably” means that the reinforcing zone is permanently fixed to the upper plate, the reinforcing zone and the upper plate are unable to be separated from one another by destroying and/or damaging part of the reinforcing zone and/or part of the upper plate. A non-detachable fastening means is for example gluing or welding;
the at least one ribbed member comprises at least one metal tube housed between two adjacent ribs of the ribbed member, each at least one metal tube extending parallel to said ribs. The at least one metal tube is configured to reinforce robustness against the mechanical forces that may be imposed on the ribbed member, in addition to the robustness conferred on the ribbed member by the two ribs. In particular, the at least one metal tube is configured to reinforce the robustness of the ribbed member against a force corresponding to an impact by compression. The at least one metal tube projects from the upper plate and makes it possible to keep the upper plate fixed relative to the reinforcing zone despite an impact by compression. It will be understood that the metal tube is a reinforcement the ribbed member having increased rigidity relative to the adjacent ribs. Advantageously, each tube is of cylindrical shape. A cross-section of each tube is formed by a closed contour, for example of circular or polynomial shape. Also advantageously, the cross-section of each tube is invariant in shape and in size between two longitudinal ends of said tube;
each metal tube extends from a face of an absorption block and towards the opposite edge of the upper plate;
in a first embodiment, each metal tube is force-fitted between two adjacent ribs. In a second alternative embodiment to the first embodiment, each metal tube is rigidly and non-detachably fixed to the upper plate. “Non-detachably” means that each metal tube is permanently fixed to the upper plate, each metal tube and the upper plate are unable to be separated from one another by destroying and/or damaging part of each metal tube and/or part of the upper plate.

A non-detachable fastening means is for example gluing or welding.

According to a second aspect, a floor arrangement for a motor vehicle is proposed, the arrangement comprising (i) a floor reinforced by two seat crossmembers extending laterally from one edge to the other of the floor and (ii) a reinforcing system according to the first aspect or according to any one of its improvements, the reinforcing system being rigidly attached to the floor at said seat crossmembers.

In the floor arrangement according to the second aspect, the floor forms a flat surface intended to form a bottom of the body of a motor vehicle.

In the floor arrangement according to the second aspect, the two seat crossmembers and the reinforcing system reinforce the floor against mechanical forces that may be imposed on the floor. By being reinforced by two seat crossmembers and by the reinforcing system, the arrangement of the floor is intended to be economical in terms of materials, avoiding the addition of further crossmembers to reinforce the floor. Such a floor arrangement is also more lightweight.

The reinforcing system has shapes and dimensions complementary to those of the seat crossmembers in order to be housed in recessed zones formed at the floor and seat crossmembers. Such a reinforcing system is non-bulky and aids in a compact floor arrangement, without affecting the interior architecture of a passenger compartment of the motor vehicle that it fits.

In the floor arrangement according to the second aspect, the absorption zone of the reinforcing system is located at an outer end of the seat crossmembers, and the reinforcing zone extends parallel to the seat crossmembers. In the motor vehicle equipped with the floor arrangement according to the second aspect, the outer end is the one situated at a lateral flank of the motor vehicle. Thus, the system in accordance with its second aspect makes it possible, following a “side pole impact” occurring at a lateral flank of the motor vehicle equipped with the floor arrangement, to first absorb a compressive force at the absorption zone, then a residual of force not absorbed by the absorption zone is transmitted into the reinforcing zone. Such a floor arrangement improves the distribution of forces at the floor of the motor vehicle that it fits and makes it possible to keep said floor rigid.

The floor arrangement for a motor vehicle in accordance with the second aspect advantageously comprises at least one of the improvements herein below; the technical features forming these improvements could be considered separately or in combination:
the reinforcing zone of the reinforcing system comprises (i) a front reinforcing ribbed member which extends longitudinally in front of a front seat crossmember, (ii) a rear reinforcing ribbed member which extends longitudinally behind a rear seat crossmember, (iii) a first intermediate reinforcing ribbed member which extends between two terminal parts of the front seat crossmember, (iv) a second intermediate reinforcing ribbed member which extends between two terminal parts of the rear seat crossmember, (v) a third intermediate reinforcing ribbed member located between the rear seat crossmember and the front seat crossmember. The floor arrangement comprising such a reinforcing zone takes advantage of a set of spaces, left vacant in the floor arrangements of the prior art, upstream, downstream and between the front seat crossmembers;
the absorption zone of the reinforcing system comprises (i) a front absorption block located in the continuation of the front reinforcing ribbed member at a front part of the floor, (ii) a rear absorption block located in the continuation of the rear reinforcing ribbed member at a rear part of the floor, (iii) a first absorption block located in the continuation of the first intermediate reinforcing ribbed member, (iv) a second absorption block located in the continuation of the second intermediate reinforcing ribbed member, (v) a third absorption block located in the continuation of the third intermediate reinforcing ribbed member.
the first absorption block and the second absorption block are identical. “Identical” means that they have the same dimensions and the same shape. Advantageously, it is understood that two “identical” elements have the same mechanical characteristics;
the front absorption block and the rear absorption block are identical to each other, and are different from the first absorption block and the second absorption block. The term “identical” refers to the fact that they have the same dimensions and the same shape, and “different”, the fact that they have distinct dimensions and a distinct shape. Advantageously, it is understood that two “identical” elements have the same mechanical characteristics, and two “different” elements have distinct mechanical characteristics;
the third absorption block is different from all the other absorption blocks. “Different” means that it has distinct dimensions and a distinct shape from the other absorption blocks. Advantageously, it is understood that two “different” elements have distinct mechanical characteristics;
the absorption zone of the reinforcing system comprises a passage for an electrical cable harness of the motor vehicle, the passage being formed by a cavity configured to be able to house the electrical cable harness. Such an absorption zone makes it possible to protect the electrical cable harness housed in the passage.

According to a third aspect, a motor vehicle is proposed including a floor arrangement in accordance with the second aspect or according to any one of its improvements.

In the motor vehicle according to the third aspect, the reinforcing system, by combining an impact absorption function intended to be implemented upstream of an impact dissipation function, makes it possible to reinforce the floor of said motor vehicle. In the motor vehicle according to the third aspect, the distribution of the forces at the floor makes it possible to keep the floor rigid, in particular during a “side pole impact”, in other words in the event of an impact occurring at a lateral flank of the motor vehicle against a narrow surface, such as a fixed obstacle in the form of a tree or a pole.

The motor vehicle according to the second aspect is for example of the BEV type, standing for Battery Electric Vehicle, provided with an electric drivetrain. The motor vehicle according to the second aspect is for example of the PHEV type, standing for Plug-in Hybrid Electric, provided both with a thermal drivetrain and an electric drivetrain. In such a motor vehicle, the floor arrangement is located at the electric batteries of said motor vehicle. Thus, this solution makes it possible to protect the electric batteries of the motor vehicle located under the floor of an electric motor vehicle, while being simple to implement.

Various embodiments are provided, integrating according to all possible combinations thereof the different optional features disclosed herein.

### BRIEF DESCRIPTION OF THE FIGURES

Other features and advantages will become more apparent through the following description, and several embodiments given for indicative and non-limiting purposes with reference to the appended schematic drawings, wherein:

FIG. 1 shows a schematic view of a motor vehicle in accordance with the third aspect.

FIG. 2 shows a schematic view of a reinforcing system according to the first aspect in a first alternative embodiment.

FIG. 3 shows a schematic view of a floor arrangement according to the second aspect equipped with the reinforcing system shown in FIG. 2.

FIG. 4 shows a first, transverse cross-sectional view of the reinforcing system shown in FIG. 2.

FIG. 5 shows a second, longitudinal cross-sectional view of the reinforcing system shown in FIG. 2.

FIG. 6 shows a schematic view of a floor arrangement according to the second aspect equipped with a second alternative embodiment of the reinforcing system according to the first aspect.

### DETAILED DESCRIPTION

Of course, the features, the variants and the different embodiments could be associated together, according to various combinations, to the extent that they are not incompatible or exclusive of one another. In particular, it is possible to imagine variants comprising only a selection of features described hereinafter in isolation from the other described features, if this selection of features is sufficient to confer a technical advantage or to differentiate the systems described herein from the prior art.

In particular, all of the described variants and embodiments could be combined together if nothing technically opposes this combination.

In the figures, the elements common to several figures keep the same reference.

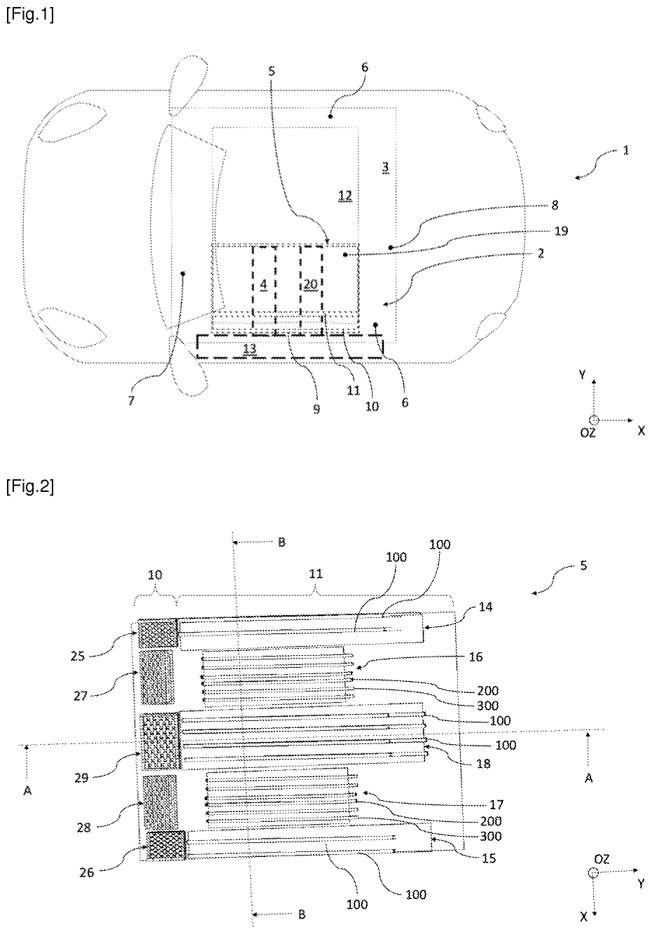

FIG. 1 shows a schematic view of a motor vehicle 1 in accordance with the third aspect, seen from above. In the remainder of the description, a reference frame is defined in which a longitudinal axis OX, a transverse axis OY and a vertical axis OZ are defined. The longitudinal axis OX corresponds to a trajectory of the motor vehicle 1 when it is moving forward, in a straight line and on a flat road. The longitudinal axis OX corresponds to a direction from the front to the rear of the motor vehicle 1, and it is oriented from the front to the rear of the motor vehicle 1. A longitudinal direction parallel to the longitudinal axis OX is also defined, the adjectives “forward”, “rear” or “front” refer to this reference direction, as does the term “length”. The transverse axis OY corresponds to the axis around which the wheels of the motor vehicle 1 rotate, and the direction of the axis OY is oriented from a driver side to a passenger side, in the non-English standard. A transverse direction parallel to the transverse axis OY is also defined, and the adjectives “lateral” or “transverse” refer to this reference direction, as does the term “width”. The vertical axis OZ is an axis perpendicular simultaneously to the axis OX and to the axis OY, and which is oriented from a floor of the motor vehicle 1 toward a roof of said motor vehicle 1, the adjectives “upper” and “lower” refer to this reference direction, as does the term “height”.

In FIG. 1, the motor vehicle 1 in accordance with the third aspect comprises a floor 3 arrangement 2 in accordance with the second aspect. The floor arrangement 2 comprises a floor 3, two seat crossmembers 4, 20 reinforcing the floor 3 and a reinforcing system 5 for the floor 3 according to the first aspect. The floor 3 comprises lateral edges 6 between which the two seat crossmembers 4, 20 extend in the transverse direction. The floor 3 further comprises a front part 7 ahead of the seat crossmembers 4, 20 and a rear part 8 behind the seat crossmembers 4, 20, relative to the longitudinal direction.

In the motor vehicle 1 according to the third aspect shown in FIG. 1, the reinforcing system 5 comprises an upper plate 9, an impact absorption zone 10 and a reinforcing zone 11. The floor 3 is comprised between the floor 3 arrangement 2 and a battery pack 12 of the motor vehicle 1 which is of the electric type. The floor 3 reinforced by the reinforcing system 5 makes it possible to preserve the battery pack 12 of the motor vehicle 1 during a compression impact. The reinforcing system 5 and the seat crossmembers 4, 20 are mounted, relative to the transverse direction, behind a side member 13 of the motor vehicle 1. The absorption zone 10 is proximal to the side member 13 of the motor vehicle 1 and the reinforcing zone 11 is distal to the side member 13 of the motor vehicle 1.

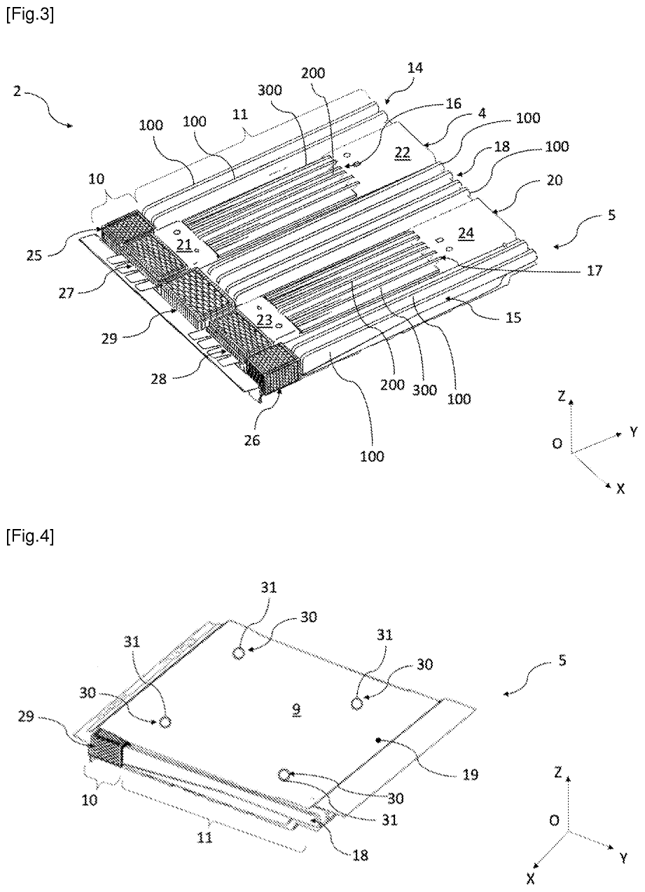

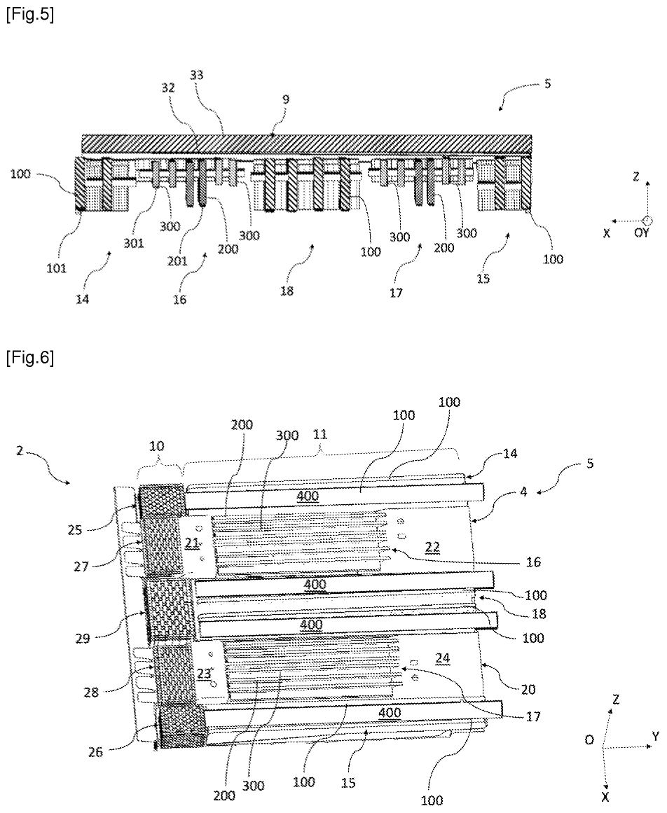

FIGS. 2 to 6 show the reinforcing system 5 according to the first aspect. A first alternative embodiment of the reinforcing system 5 according to the first aspect is shown in FIGS. 2 to 5, and a second alternative embodiment is shown in FIG. 6. FIG. 4 shows a first transverse section AA, shown in FIG. 2, of the reinforcing system 5 shown in FIG. 2 and FIG. 5 shows a second longitudinal section BB, shown in FIG. 2, of the reinforcing system 5 shown in FIG. 2. In FIGS. 2, 3 and 6, the reinforcing system 5 is shown in the top, without its upper plate 9 in order to facilitate the understanding of said FIGURES. In FIG. 3 and FIG. 6, the seat crossmembers 4, 20 are shown to show a relative positioning of the seat crossmembers 4, 20 and of the reinforcing system 5. FIGS. 3 and 6 show in particular a schematic view of the arrangement 2 of the floor 3 according to the second aspect equipped with the reinforcing system 5 according to one of its alternative embodiments.

With reference to FIGS. 2, 3 and 6, the reinforcing zone 11 comprises at least one ribbed member 14, 15, 16, 17, 18 extending longitudinally from the absorption zone 10. In this case, the reinforcing zone 11 comprises five ribbed members 14, 15, 16, 17, 18.

In the reinforcing system 5 according to the first aspect shown in FIGS. 2, 3 and 6, the reinforcing zone 11 comprises a front reinforcing ribbed member 14, a rear reinforcing ribbed member 15, a first intermediate reinforcing ribbed member 16, a second intermediate reinforcing ribbed member 17 and a third intermediate reinforcing ribbed member 18.

FIGS. 3 and 6 show that the front reinforcing ribbed member 14 extends longitudinally in front of a front seat crossmember 4. The rear reinforcing ribbed member 15 extends longitudinally behind a rear seat crossmember 20. The first intermediate reinforcing ribbed member 16 extends between two terminal parts 21, 22 of the front seat crossmember 4. The second intermediate reinforcing ribbed member 17 extends between two terminal parts 23, 24 of the rear seat crossmember 20. The third intermediate reinforcing ribbed member 18 is located between the rear seat crossmember 20 and the front seat crossmember 4.

With reference to FIGS. 2, 3 and 6, each ribbed member 14, 15, 16, 17, 18 comprises at least two ribs 100, 200, 300 extending parallel to each other and having a rectangular transverse profile.

In the present case, in the first alternative embodiment of the reinforcing system shown in FIG. 2, the front reinforcing ribbed member 14 comprises two ribs 100. The rear reinforcing ribbed member 15 comprises two ribs 100. The first intermediate reinforcing ribbed member 16 comprises six ribs 200, 300. The second intermediate reinforcing ribbed member 17 comprises six ribs 200, 300. The third intermediate reinforcing ribbed member 18 comprises four ribs 100.

In the present case, in the second alternative embodiment of the reinforcing system 5 shown in FIG. 6, the front reinforcing ribbed member 14 of the reinforcing system 5 and the rear reinforcing ribbed member 15 of the reinforcing system 5 each comprise two ribs 100 and a metal tube 400 housed between two adjacent ribs 100 of the ribbed member 14, 15 in question. The third intermediate reinforcing ribbed member 18 of the reinforcing system 5 comprises two adjacent ribs 100 and two metal tubes 400 housed on either side of the two adjacent ribs 100. Each metal tube 400 extends parallel to the ribs 100 of the ribbed member 14, 15, 18 in question. The first intermediate reinforcing ribbed member 16 comprises six ribs 200, 300. The second intermediate reinforcing ribbed member 17 comprises six ribs 200, 300.

With reference to FIGS. 2, 3 and 6, the absorption zone 10 of the reinforcing system 5 comprises at least one absorption block 25, 26, 27, 28, 29 configured to deform with constant force. In this case, the absorption zone 10 comprises five ribbed members 25, 26, 27, 28, 29. Each absorption block 25, 26, 27, 28, 29 is formed of a honeycomb structure of the type of a hollow lattice structure configured to undergo a programmed deformation in response to an impact occurring laterally.

In the reinforcing system 5 according to the first aspect shown in FIGS. 2, 3 and 6, the absorption zone 10 of the reinforcing system 5 comprises a front absorption block 25, a rear absorption block 26, a first absorption block 27, a second absorption block 28 and a third absorption block 29.

FIG. 3 shows that the front absorption block 25 is located in the continuation of the front reinforcing ribbed member 14 at the front part 7 of the floor 3. The rear absorption block 26 situated in the continuation of the rear reinforcing ribbed member 15 at the rear part 8 of the floor 3. The first absorption block 27 is situated in the continuation of the first intermediate reinforcing ribbed member 16. The second absorption block 28 is situated in the continuation of the second intermediate reinforcing ribbed member 17. The third absorption block 29 is situated in the continuation of the third intermediate reinforcing ribbed member 18.

With reference to FIGS. 2, 3 and 6, the first absorption block 27 and the second absorption block 28 are identical in shape, dimension, and mechanical properties, in particular in their ability to deform. The front absorption block 25 and the rear absorption block 26 are identical in shape, dimension, and mechanical properties, in particular in their ability to deform. The front absorption block 25 and the rear absorption block 26 are different from the first absorption block 27 and from the second absorption block 28, in shape, dimension, and mechanical properties, in particular in their ability to deform. The third absorption block 29 is different from all the other absorption blocks, in shape, dimension, and mechanical properties, in particular in its ability to deform.

In the reinforcing system 5 shown in FIG. 4, the upper plate 9 comprises members 30 for fastening to the floor 3 formed by four orifices 31.

In the reinforcing system 5 shown in FIG. 4, the absorption blocks 25, 26, 27, 28, 29, in particular the third absorption block 29 visible in cross-section, and the ribbed members 14, 15, 16, 17, 18, in particular the third intermediate reinforcing ribbed member 18 on the cross-section, are secured to the upper plate 9.

In the reinforcing system 5 shown in FIG. 4, the reinforcing zone 11 is secured to the upper plate 9 and extending longitudinally in the continuation of the absorption zone 10. The ribbed members 14, 15, 16, 17, 18 extend longitudinally from the absorption zone 10 towards an opposite edge 19 of the upper plate 9.

FIG. 5 shows that the ribbed members 14, 15, 16, 17, 18 project from a lower face 32 of the upper plate 9 in the vertical direction, the lower face 32 being opposite an upper face 33 of the upper plate 9. The ribs 100 of the front reinforcing ribbed member 14, the ribs 100 of the rear reinforcing ribbed member 15 and the ribs 100 of the third reinforcing ribbed member 18 have an identical profile. The first intermediate reinforcing ribbed member 16 and the second intermediate reinforcing ribbed member 17 have an identical profile. The first intermediate reinforcing ribbed member 16 and the second intermediate reinforcing ribbed member 17 comprise two types of ribs 200, 300, namely two adjacent intermediate ribs 200 comprised between two front adjacent ribs 300 and two rear adjacent ribs 300. The intermediate adjacent ribs 200 have a free edge 201 comprised between a free edge 301 of the front adjacent ribs 300 and a free edge 101 of the ribs 100 of the front reinforcing ribbed member 14.

In summary, related herein is a reinforcing system 5 for a motor vehicle 1 floor 3, the reinforcing system 5 comprising an upper plate 9 comprising members 30 for fastening to the floor 3, an impact absorption zone 10 and a reinforcing zone 11. The absorption zone 10 is secured to the upper plate 9 and is configured to be able to deform with constant force under the effect of an impact. The reinforcing zone 11 is rigid, is configured to be able to transmit a compressive force subsequent to the impact, is secured to the upper plate 9 and extends longitudinally in the continuation of the absorption zone 10.

Of course, the systems described herein are not limited to the examples that have just been described and numerous modifications could be made to these examples without departing from the scope In particular, the different features, shapes, variants and embodiments could be associated together according to various combinations to the extent that they are not incompatible or exclusive of one another. In particular, all of the previously-described variants and embodiments may be combined together.

1. A reinforcing system for a motor vehicle floor, the reinforcing system comprising:
an upper plate comprising fastening members to the floor;
an impact absorption zone secured to the upper plate, the absorption zone being configured to be able to deform with constant force under the effect of an impact;
a rigid reinforcing zone configured to be able to transmit a compressive force subsequent to the impact, the reinforcing zone being secured to the upper plate and extending longitudinally in the continuation of the absorption zone.

2. The reinforcing system according to claim 1, wherein the absorption zone comprises at least one absorption block configured to deform with constant force, each at least one absorption block being secured to the upper plate.

3. The reinforcing system according to claim 2, wherein each absorption block is formed of a honeycomb structure.

4. The reinforcing system according to claim 1, wherein the rigid reinforcing zone comprises at least one reinforcing ribbed member secured to Preliminary Amendment the upper plate, each ribbed member projecting from the upper plate and extending longitudinally from the absorption zone and towards an opposite edge of the upper plate.

5. The reinforcing system according to claim 4, wherein each ribbed member comprises at least two ribs extending parallel to each other and having a rectangular transverse profile.

6. The reinforcing system according to claim 5, wherein the at least one ribbed member comprises at least one metal tube housed between two adjacent ribs of the ribbed member, each at least one metal tube extending parallel to said ribs.

7. A floor arrangement for a motor vehicle, the arrangement comprising:
a floor reinforced by two seat crossmembers (4, 20) extending laterally from one edge of the floor to the other;
a reinforcing system according to claim 1, the reinforcing system being rigidly attached to the floor at said seat crossmembers.

8. The floor arrangement according to claim 7, wherein the reinforcing zone of the reinforcing system comprises:
a front reinforcing ribbed member that extends longitudinally forward of a front seat crossmember;
a rear reinforcing ribbed member extends longitudinally behind a rear seat crossmember;
a first intermediate reinforcing ribbed member extends between two terminal parts of the front seat crossmember;
a second intermediate reinforcing ribbed member extends between two terminal parts of the front seat crossmember;
the third intermediate reinforcing ribbed member is located between the rear seat crossmember and the front seat crossmember.

9. The floor arrangement according to claim 8, wherein the absorption zone of the reinforcing system comprises:
a front absorption block located in the continuation of the front reinforcing ribbed member at a front part of the floor;
a rear absorption block situated in the continuation of the rear reinforcing ribbed member at a rear part of the floor;
a first absorption block situated in the continuation of the first intermediate reinforcing ribbed member;
a second absorption block situated in the continuation of the second intermediate reinforcing ribbed member;
a third absorption block situated in the continuation of the third intermediate reinforcing ribbed member.

10. A motor vehicle comprising a floor arrangement according to claim 7.
